(19) United States
(12) Patent Application Publication
(10) Pub. No.: US 2016/0009508 A1
(43) Pub. Date: Jan. 14, 2016

(54) System and Method for Reducing Shipping Costs

(71) Applicant: Joseph Gaikoski, Allen, TX (US)

(72) Inventor: Joseph Gaikoski, Allen, TX (US)

(21) Appl. No.: 14/673,360

(22) Filed: Mar. 30, 2015

Related U.S. Application Data
(60) Provisional application No. 61/971,852, filed on Mar. 28, 2014.

(51) Int. Cl. B65G 67/20; B65D 88/54; B65G 65/00; B65D 21/08

(52) U.S. Cl. CPC B65G 67/20; B65D 21/086; B65D 88/54; B65G 65/00

(57) ABSTRACT

Systems and methods for loading freight containers are disclosed. The inventive system and method is used to reduce excess shipping costs resulting from the use of dimensional weight in calculating freight charges. The invention is comprised of various loading combinations for boxes optimally sized to fit on standard palettes. Through use of the invention, the higher shipping costs increased dimensional weight of lighter packages can be alleviated.

### RELATED APPLICATION

This application claims priority to U.S. Provisional Patent Application No. 61/971,852.

### FIELD OF THE INVENTION

The present invention relates generally to an apparatus and method for reducing freight shipping costs when shipping prices are based on dimensional weight. The invention has applications in air, land and sea freight. In one embodiment of the invention, the novel telescoping box system is used with pallets of a specific sizes to further reduce waste and cost in the shipping process.

### BACKGROUND OF THE INVENTION

In the freight forwarding business, domestic and international shippers will often base delivery rates not only on the weight of a package but also on its dimensional volume which taken together are sometimes referred to as “dimensional weight.” The determination of dimensional weight to calculate shipping cost has become necessary as the cost of transportation has gone up. Not only is the weight of a package a factor in cost but also the space or volume that that package occupies. Consideration of dimensional volume is especially critical in air cargo shipping where cargo space is especially limited and where weight determination alone would be an inadequate basis for calculating the value of the space taken up by a package. Dimensional volume consideration is also important in surface transportation such as truck or train service where cubicle space is limited.

The concept of dimensional weight has been adopted by the transportation industry worldwide as a uniform means of establishing a minimum charge for the cubic space a package occupies. Dimensional weight is a calculation of a theoretical weight of a package. This theoretical weight is the weight of the package at a minimum density chosen by the freight carrier. If the package is below this minimum density, then the actual weight is irrelevant as the freight carrier will charge for the volume of the package as if it were of the chosen density (what the package would weigh at the minimum density). Furthermore, the volume used to calculate the dimensional weight may not be absolutely representative of the true volume of the package. The freight carrier will measure the longest dimension in each of the three axis (X, Y, Z) and use these measurements to determine the package volume. If the package is a right-angled rectangular cuboid (box), then this will be equal to the true volume of the package. However, if the package is of any other shape, then the calculation of volume will be more than the true volume of the package.

Dimensional weight is also known as DIM weight, volumetric weight, cubed weight, etc. Freight carriers utilize the greater of the actual weight or dimensional weight to calculate shipping charges. Dimensional weight is calculated as (Length×Width×Height)/(Dimensional Factor). Measurements can be made all in inches or all in centimeters, but the appropriate shipping factor must also be used.

Shipping factors for imperial measurements represent cubic inches per pound (in³/lb) while metric factors represent cubic centimeters per kilogram (cm³/kg). These are the inverse of the package density. Dimensional weight is applied when the actual product density is less than the minimum density represented by the chosen factor. Dimensional weight is representative of the weight of the package at the minimum density accepted by the freight carrier. Shipping factors are not only different for imperial and metric measurements, but also for shipment mode and in some cases between different customers.

Furthermore, containerization for transport has spurred the use of pallets because the shipping containers have the smooth, level surfaces needed for easy pallet movement. Most pallets can easily carry a load a 1,000 kg (2,205 lb). Today, over half a billion pallets are made each year and about two billion pallets are in use across the United States alone.

Pallets make it easier to move heavy stacks. Loads with pallets under them can be hauled by forklift trucks of different sizes, or even by hand-pumped and hand-drawn pallet jacks. Movement is easy on a wide, strong, flat floor.

The lack of a single international standard for pallets causes substantial continuing expense. The following table illustrates the various dimensions of pallets in common use:

| Dimensions, in (W × L) | Industries Using |
|---|---|
| 48 × 40 | Grocery, many others |
| 42 × 42 | Telecommunications, Paint |
| 48 × 48 | Drums |
| 40 × 48 | Military, Cement |
| 48 × 42 | Chemical, Beverage |
| 40 × 40 | Dairy |
| 48 × 45 | Automotive |
| 44 × 44 | Drums, Chemical |
| 36 × 36 | Beverage |
| 48 × 36 | Beverage, Shingles, Packaged Paper |
| 35 × 45.5 | Military ½ ISO container, |
| | fits 36″ standard doors |
| 48 × 20 | Retail |

### SUMMARY OF THE INVENTION

This invention relates to using a novel system of telescoping boxes to reduce the inefficiencies of dimensional weight and the disproportionate cost of shipping lighter packages when shipping prices are based on dimensional weight. The invention has applications in air, land and sea freight. In one embodiment of the invention, the novel telescoping box system is used with pallets of a specific sizes to further reduce waste and cost in the shipping process. The scoping boxes are used in a variety of loading combinations. The loading combinations are suited to the pallet and shipping container. Through use of the disclosed methods and system, shipping costs may be significantly reduced.

### BRIEF DESCRIPTION OF THE DRAWINGS

Embodiments of the invention will now be described, by way of example, with reference to the accompanying drawings, wherein:

FIG. 1 describes the telescoping box sizes and corresponding pallets used in one embodiment of the invention.

FIG. 2 describes the loading combinations available in an embodiment of the invention with the alphabetical indication of the telescoping box sizes from FIG. 1.

FIG. 3 provides exemplary cost savings from use of the invention.

### DETAILED DESCRIPTION

The following description provides details with reference to the accompanying drawings. It should be understood that the invention may be embodied in many different forms and should not be construed as limited to the embodiments set forth herein.

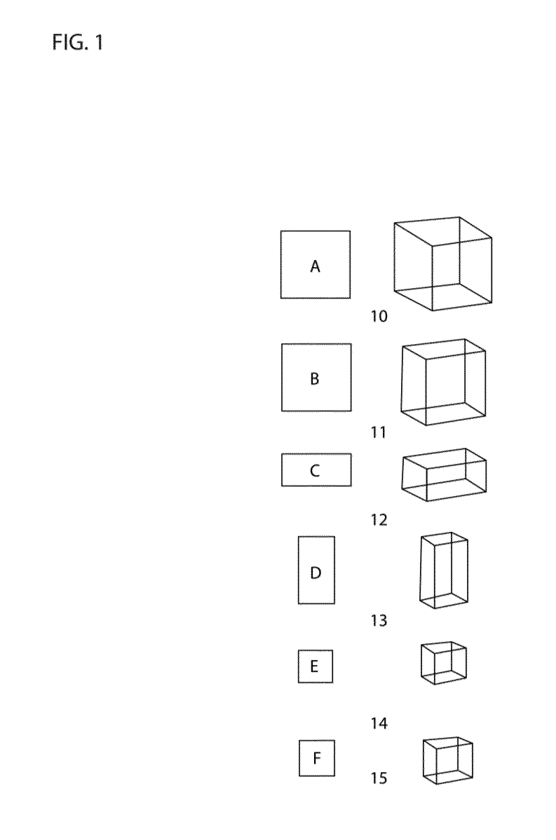

Referring to FIG. 1, the inventive method and system incorporate the use of specific box sizes with specific telescoping properties such that they fit on pallets with minimal waste of space. By way of example, the “A” large box 10 has dimensions of 45 in.×45 in.×32.5 in. and is optimized for use with a 45 in.×45 in. heat treated pallet. The “A” large box 10 is capable of telescoping from 32.5 in. to 55 in. The “A” large box 10 has inside dimensions of 44.5 in.×44.5 in.×32 in. The “B” medium box 11 has dimensions of 45 in.×30 in.×32.5 in. and is optimized for use with a 45 in.×30 in. heat treated pallet. The “B” medium box 11 is capable of telescoping from 32.5 in. to 55 in. The “B” medium box 11 has inside dimensions of 44.5 in.×29.5 in.×32 in. The “C” short medium box 12 has dimensions of 45 in.×30 in.×16 in. and is optimized for use with a 45 in.×30 in. heat treated pallet. The “C” short medium box 12 is capable of telescoping from 16 in. to 27.5 in. The “C” short medium 12 box has inside dimensions of 44.5 in.×29.5 in.×15.5 in. The “D” tall box 13 has dimensions of 22.5 in.×15 in.×32.5 in. and is optimized for use with a 22.5 in.×15 in. heat treated pallet. The “D” tall box 13 is capable of telescoping from 32in. to 55 in. The “D” tall box 13 has inside dimensions of 22 in.×14.5 in.×32 in. The “E” small box 14 has dimensions of 22.5 in.×15 in.×16 in. and is optimized for use with a 22.5 in.×15 in. heat treated pallet. The “E” small box 14 is capable of telescoping from 16 in. to 27.5 in. The “E” small box 14 has inside dimensions of 22 in.×14.5 in.×15.5 in. The “F” standard box 15 has dimensions of 22.5 in.×22.5 in.×30 in. and is optimized for use with a 22.5 in.×23.5 in. heat treated pallet. The “F” standard box 15 is capable of telescoping from 20 in. to 32 in. The “F” standard box 15 has inside dimensions of 22 in.×22 in.×19.5 in. When using the inventive system, a shipper may select the appropriate box sizes along with the appropriate pallet size and telescope the box as needed in order to minimize the dimensional weight of the item to be shipped.

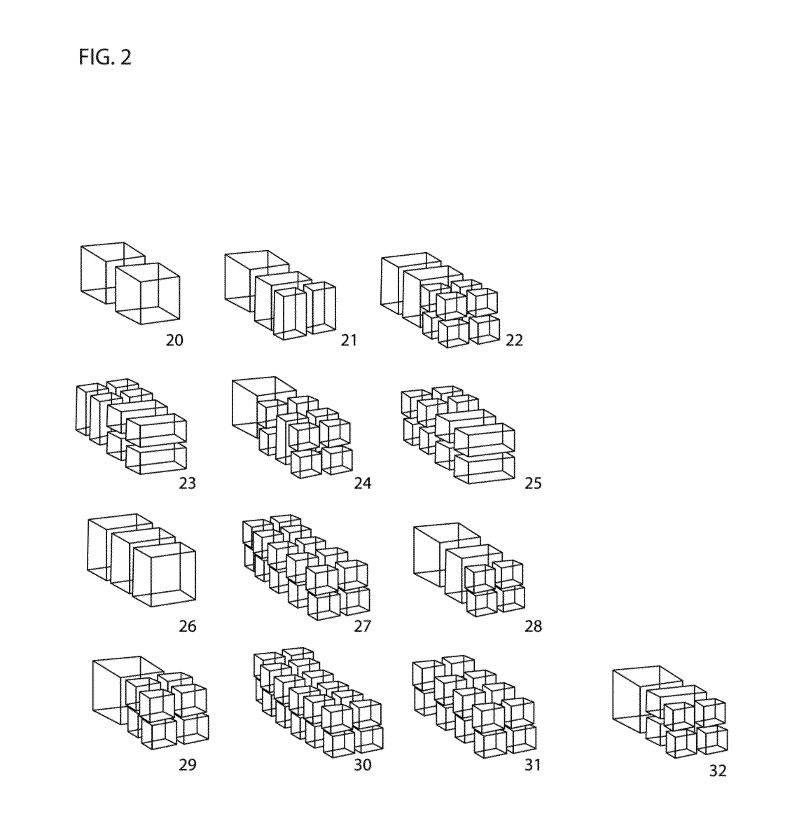

FIG. 2 describes the various loading combinations used when implementing an embodiment of the invention. For example, the disclosed configurations may be used to create a load having a base of 90 in. by 45 in. This load may be optimized to fit into a standard air freight, ground shipping or sea-going container with minimal waste of space such that the cost to the shipper is reduced. For example, a standard 53 foot ground shipping container can be loaded more efficiently with the inventive loading combinations such that there is a reduction of wasted space within the container. In loading combination 20, the load is comprised of two “A” large boxes. In loading combination 21, the load is comprised of one “A” large box, one “B” medium box and two “D” tall boxes. In loading combination 22, the load is comprised of two “B” medium boxes and eight “E” small boxes. In loading combination 23, the load is comprised of four “D” tall boxes and four “C” short medium boxes. In loading combination 24, the load is comprised of one “A” large box, eight “E” small boxes, and two “D” tall boxes. In loading combination 25, the load is comprised of eight “E” small boxes and four “C” short medium boxes. In loading combination 26, the load is comprised of three “B” medium boxes. In loading combination 27, the load is comprised of twelve “E” small boxes and eight “F” standard boxes. In loading combination 28, the load is comprised of one “A” large box, one “B” medium box, and four “D” small boxes. In loading combination 29, the load is comprised of one “A” large box and eight “F” standard boxes. In loading combination 30, the load is comprised of twenty-four “E” small boxes. In loading combination 31, the load is comprised of sixteen “F” standard boxes. In loading combination 32, the load is comprised of one “A” large box, two “C” short medium boxes, and four “E” small boxes.

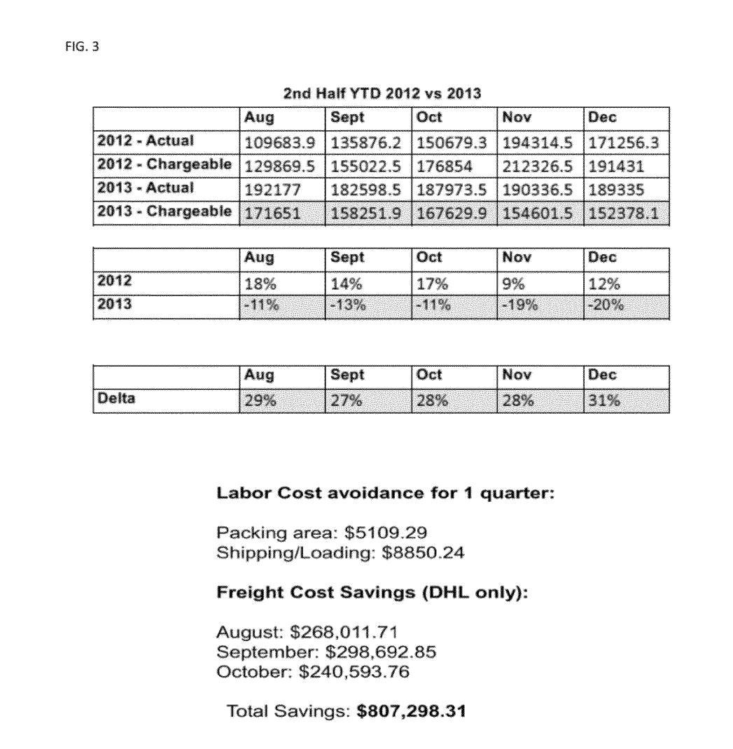

FIG. 3 describes cost avoidance and freight saving exhibited when implanting the inventive method and system. In this instance, a shipper experienced savings ranging from 27% to 31% when implementing the inventive method and system.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A system for loading a freight container comprising at least two or more boxes having characteristics selected from the following list in a loading combination;
a) a large box having outside dimensions of 45 in.×45 in.×32.5 in. and inside dimensions of 44.5 in.×44.5 in.×32 in.;
b) a medium box having outside dimensions of 45 in.×30 in.×32.5 in. and inside dimensions of 44.5 in.×29.5 in.×32 in.;
c) a short medium box having outside dimensions of 45 in.×30 in.×16 in. and has inside dimensions of 44.5 in.×29.5 in.×15.5 in.;
d) a tall box having outside dimensions of 22.5 in.×15 in.×32.5 in. and inside dimensions of 22 in.×14.5 in.×32 in.;
e) a small box having outside dimensions 22.5 in.×15 in.×16 in. and inside dimensions of 22 in.×14.5 in.×15.5 in; or
f) a standard box having outside dimensions of 22.5 in.×22.5 in.×30 in. and inside dimensions of 22 in.×22 in.×19.5 in.

2. The system of claim 1 wherein the loading combination is comprised of two large boxes.

3. The system of claim 1 wherein the loading combination comprised of one large box, one medium box and two tall boxes.

4. The system of claim 1 wherein the loading combination is comprised of two medium boxes and eight small boxes.

5. The system of claim 1 wherein the loading combination is comprised of four tall boxes and four short medium boxes.

6. The system of claim 1 wherein the loading combination is comprised of one large box, eight small boxes, and two tall boxes.

7. The system of claim 1 wherein the loading combination is comprised of eight small boxes and four short medium boxes.

8. The system of claim 1 wherein the loading combination is comprised of three medium boxes.

9. The system of claim 1 wherein the loading combination is comprised of twelve small boxes and eight standard boxes.

10. The system of claim 1 wherein the loading combination is comprised of one large box, one medium box, and four small boxes.

11. The system of claim 1 wherein the loading combination is comprised of one large box and eight standard boxes.

12. The system of claim 1 wherein the loading combination is comprised of twenty-four small boxes.

13. The system of claim 1 wherein the loading combination is comprised of sixteen standard boxes.

14. The system of claim 1 wherein the loading combination is comprised of one large box, two short medium boxes, and four small boxes.

15. The system of claim 1 wherein the large box is capable of telescoping from 32.5 in. to 55 in.

16. The system of claim 1 wherein the medium box is capable of telescoping from 32.5 in. to 55 in.

17. The system of claim 1 wherein the short medium box is capable of telescoping from 16 in. to 27.5 in.

18. The system of claim 1 wherein the tall box is capable of telescoping from 32 in. to 55 in.

19. The system of claim 1 wherein the small box is capable of telescoping from 16 in. to 27.5 in.

20. The system of claim 1 wherein the standard box is capable of telescoping from 20 in. to 32 in.

21. A method for loading a freight container comprising loading into the container at least two or more boxes having characteristics selected from the following list in a loading combination:
g) a large box haying outside dimensions of 45 in.×45 in.×32.5 in. and inside dimensions of 44.5 in.×44.5 in.×32 in.;
h) a medium box having outside dimensions of 45 in.×30 in.×32.5 in. and inside dimensions of 44.5 in.×29.5 in.×32 in.;
i) a short medium box having outside dimensions of 45 in.×30 in.×16 in. and has inside dimensions of 44.5 in.×29.5 in.×15.5 in.;
j) a tall box having outside dimensions of 22.5 in.×15 in.×32.5 in. and inside dimensions of 22 in.×14.5 in.×32 in.;
k) a small box having outside dimensions of 22.5 in.×15 in.×16 in. and inside dimensions of 22 in.×14.5 in.×15.5 in.; or
l) a standard box having outside dimensions of 22.5 in.×22.5 in.×30 in, and inside dimensions of 22 in.×22 in.×19.5 in.

22. The method of claim 21 wherein the loading combination is comprised of two large boxes.

23. The method of claim 21 wherein the loading combination comprised of one large box, one medium box and two tall boxes.

24. The method of claim 21 wherein the loading combination is comprised of two medium boxes and eight small boxes.

25. The method of claim 21 wherein the loading combination is comprised of four tall boxes and four short medium boxes.

26. The method of claim 21 wherein the loading combination is comprised of one large box, eight small boxes, and two tall boxes.

27. The method of claim 21 wherein the loading combination is comprised of eight small boxes and four short medium boxes.

28. The method of claim 21 wherein the loading combination is comprised of three medium boxes.

29. The method of claim 21 wherein the loading combination is comprised of twelve small boxes and eight standard boxes.

30. The method of claim 21 wherein the loading combination is comprised of one large box, one medium box, and four small boxes.

31. The method of claim 21 wherein the loading combination is comprised of one large box and eight standard boxes.

32. The method of claim 21 wherein the loading combination is comprised of twenty-four small boxes.

33. The method of claim 21 wherein the loading combination is comprised of sixteen standard boxes.

34. The method of claim 21 wherein the loading combination is comprised of one large box, two short medium boxes, and four small boxes.

35. The method of claim 21 wherein the large box is capable of telescoping from 32.5 in. to 55 in.

36. The method of claim 21 wherein the medium box is capable of telescoping from 32.5 in. to 55 in.

37. The method of claim 21 wherein the short medium box is capable of telescoping from 16 in. to 27.5 in.

38. The method of claim 21 wherein the tall box is capable of telescoping from 32 in. to 55 in.

39. The method of claim 21 wherein the small box is capable of telescoping from 16 in. to 27.5 in.

40. The method of claim 21 wherein the standard box is capable of telescoping from 20 in. to 32 in.
